(19) United States
(12) Patent Application Publication
(10) Pub. No.: US 2026/0155414 A1
(43) Pub. Date: Jun. 4, 2026

(54) ARTICLES HAVING MICROPOROUS SUBSTRATES WITH CONFORMAL COATING, AND METHODS FOR MAKING AND USING SAME

(71) Applicant: W. L. Gore & Associates, Inc., Newark, DE (US)

(72) Inventors: COREY A. ABRAMS, Weehawken, NJ (US); ROCHITHA R. NATHAN, Philadelphia, PA (US); PHUONG Q. HUA, Newark, DE (US); MARK D. EDMUNDSON, Rancho Palos Verdes, CA (US)

(73) Assignee: W. L. Gore & Associates, Inc., Newark, DE (US)

(21) Appl. No.: 19/122,632

(22) PCT Filed: Oct. 19, 2023
(86) PCT No.: PCT/US2023/035529

§ 371 Date: Apr. 18, 2025

Related U.S. Application Data
(60) Provisional application No. 63/417,688, filed on Oct. 19, 2022.
(60) Provisional application No. 63/419,695, filed on Oct. 26, 2022.

(51) Int. Cl. H01M 8/1004; H01M 8/1053; H01M 8/106; H01M 8/1062; H01M 8/1067

(52) U.S. Cl. CPC H01M 8/1004; H01M 8/1053; H01M 8/106; H01M 8/1062; H01M 8/1067

(57) ABSTRACT

A composite material including a polymer substrate having a microporous structure, and a conformal coating disposed about a surface of the polymer substrate, wherein the conformal coating is formed of metal nanoparticles that are sintered.

### CROSS-REFERENCE TO RELATED APPLICATION

This application claims the benefit of Provisional Application No. 63/419,695, filed Oct. 26, 2022, and Provisional Application No. 63/417,688, filed Oct. 19, 2022, which are incorporated herein by reference in their entireties for all purposes.

### FIELD

The present disclosure relates generally to articles having metallized microporous substrates. More specifically, the disclosure relates to articles having microporous substrates with conformal coatings formed of sintered metal nanoparticles, and associated methods of making and using such articles.

### BACKGROUND

Conductive articles are implemented in a variety of settings, including in energy storage and energy conversion applications. Some conductive articles include porous substrates that are conductive or are treated to be conductive (e.g., coated with a conductive material). The porosity of such substrates may serve a variety of important functions such as enabling mass transport and/or reducing the weight of the conductive article. There is interest in preparing porous conductive materials with specific characteristics such as high conductivity, high durability, high flexibility, high strength, and so forth.

As it relates to conductive coatings on substrates, some coatings include metals, and the application of such metal coatings may be described as “metallization” of the coated substrate. Some approaches to metallization may be very time-consuming, use expensive processing aids, and/or leave residual contaminants that may create fitness-for-use issues in certain applications. For example, in electroless plating, the surface to be metallized is typically activated first using materials such as a palladium/tin activator solution (i.e., depositing a so-called “seed layer”). This complicates the process, and adds cost due to the expense of materials such as palladium. Other metallization processes may require that the surface of the substrate first be coated with another material, a so-called “tie layer,” which metal can coat more easily. However, the use of a tie layer may involve similar drawbacks to those described above—it complicates the process and can leave behind undesirable residue.

Furthermore, as it relates to metallization of porous substrates, some porous substrates may be challenging to metallize due to a variety of aggravating factors. As a first example of an aggravating factor, substrates with tortuous pore phases may result in uneven metallization of interior surfaces due to so-called “shadowing” effects when the metallization is performed via substantially line-of-sight techniques, such as sputtering or evaporation. As a second example of an aggravating factor, substrates that are moderately or highly vulnerable to radiation and/or thermal damage may result in degraded properties (e.g., mechanical properties) when the metallization is performed via high-energy techniques, such as sputtering. As a third example of an aggravating factor, substrates with low surface energies may result in coatings with poor adhesion and significant numbers of defects and/or regions of uncoated substrate.

What are needed are improved conductive porous articles, and improved processes for producing conductive porous articles.

### SUMMARY

The present disclosure relates to conductive microporous articles with specific characteristics (e.g., high conductivity, high durability, and high flexibility) and optimized porosity and pore morphology; and processes for metallization of microporous substrates, where such processes are simplified, fast, require less chemicals, can coat the interior surfaces of a microporous substrate with tortuous pores, can apply durable coatings to low-surface-energy substrates with high coverage and/or few defects, minimize degradation of the substrate, and/or do not leave undesirable residuals (e.g., seed layers or tie layers).

As it relates to porous substrates for metallization, microporous polymer substrates (e.g., microporous polymer membranes) may have desirable properties such as mechanical strength, tailorable morphology, and high surface area. However, they may exhibit some or all of the aggravating factors described in the Background section. An exemplary substrate that may exhibit some or all of these desirable properties and aggravating factors is expanded polytetrafluoroethylene (ePTFE). The present disclosure relates to providing durable, conformal metal coatings on the surfaces (including the interior surfaces) of a microporous polymer substrate (e.g., ePTFE) despite the challenges described herein.

As discussed herein, the porosity of such conductive microporous articles may serve a variety of important functions such as enabling mass transport and/or reducing the weight of the conductive article. Therefore, there is interest in optimizing the porosity and pore morphology, for example to provide robust and optimized mass transport. There is also interest in minimizing the amount of conductive coating required, for example to minimize the weight and/or cost of the conductive article. In some cases, it may be desirable to treat a microporous material to be conductive substantially or completely through the bulk of the material (e.g., substantially or completely through the thickness of a porous flat sheet).

The present disclosure provides a microporous polymer substrate with a conformal coating formed of sintered metal nanoparticles. The present disclosure also relates to embodiments in which a microporous polymer substrate with a conformal coating formed of sintered metal nanoparticles is implemented with respect to an electrode.

According to an embodiment (“Embodiment 1”) a composite material includes a polymer substrate having a porous structure, and a conformal coating disposed about a surface of the polymer substrate, wherein the conformal coating is formed of metal nanoparticles that are sintered.

According to another embodiment, further to Embodiment 1, the surface includes an interior surface defined by the porous structure, and the conformal coating is disposed on the interior surface of the polymer substrate.

According to another embodiment, further to Embodiment 1, the conformal coating is a continuous coating on the surface, including the interior surface, of the polymer substrate.

According to another embodiment, further to Embodiment 1, the porous structure of the polymer substrate includes nodes and/or fibrils, wherein the conformal coating is positioned about the nodes and/or fibrils of the polymer substrate.

According to another embodiment, further to Embodiment 1, the porous structure of the polymer substrate is microporous.

According to another embodiment, further to Embodiment 1, the conformal coating is selected from one of a platinum coating, iridium coating, ruthenium coating, palladium coating, gold coating, silver coating, copper coating, nickel coating, indium coating, combinations thereof, alloys thereof, including alloys with transition metals, and/or oxides thereof.

According to another embodiment, further to Embodiment 1, the polymer substrate is a membrane.

According to another embodiment, further to Embodiment 1, the polymer substrate is expanded polytetrafluoroethylene.

According to another embodiment, further to Embodiment 1, the composite material is about 1 micrometer to about 100 micrometers in thickness.

According to another embodiment, further to Embodiment 1, the composite material has a ratio of the volume of the conformal coating to the volume of the pore phase from 0.001 to 1.0.

According to another embodiment, further to Embodiment 1, the composite material has a mean flow pore size of at least 2× larger than the volume-average particle size of the metal nanoparticles.

According to another embodiment, further to Embodiment 1, the conformal coating is a conductive coating having a metal retention of greater than 90 wt %.

According to another embodiment (“Embodiment 2”), further to Embodiment 1, the composite material includes an ion exchange material.

According to another embodiment, further to Embodiment 2, the ion exchange material is selected from one of an anion exchange material and a cation exchange material.

According to another embodiment, further to Embodiment 2, the ion exchange material is selected from a hydrocarbon polymer, a fluorocarbon polymer, and a perfluorocarbon polymer.

According to another embodiment, further to Embodiment 2, the ion exchange material is a perfluorosulfonic acid.

According to another embodiment (“Embodiment 3”), further to Embodiment 2, a membrane electrode assembly comprising the composite material of any of the preceding Embodiments coupled to an electrochemical separator.

According to another embodiment, further to Embodiment 3, the electrochemical separator includes an ion exchange material.

According to another embodiment, further to Embodiment 3, the ion exchange material is selected from one of an anion exchange material and a cation exchange material.

According to another embodiment, further to Embodiment 3, the ion exchange material is selected from a hydrocarbon polymer, a fluorocarbon polymer, and a perfluorocarbon polymer.

According to another embodiment, further to Embodiment 3, the ion exchange material is a perfluorosulfonic acid.

According to another embodiment (“Embodiment 4”), an article includes the composite material of any of the preceding Embodiments.

According to another embodiment, further to Embodiment 4, the article is an electrochemical cell.

According to another embodiment, further to Embodiment 4, the article is a fuel cell.

According to another embodiment, further to Embodiment 4, the article is an electrolyzer.

According to another embodiment (“Embodiment 5”), an article includes a microporous polymer substrate continuously and conformally coated by sintered metal nanoparticles

According to another embodiment, further to Embodiment 5, the sintered metal nanoparticles are coating an interior surface of the microporous polymer substrate.

According to another embodiment, further to Embodiment 5, the microporous polymer substrate includes a node and fibril microstructure, wherein the sintered metal nanoparticles are coating the nodes and fibrils of the microporous polymer substrate.

According to another embodiment (“Embodiment 6”), a method of forming a composite material includes providing a polymer substrate having a porous structure; imbibing the polymer substrate with metal nanoparticles; and heating the metal nanoparticles to sinter the metal nanoparticles to form a conformal coating on a surface of the polymer substrate.

According to another embodiment, further to Embodiment 6, the method further includes preparing a dispersion including the metal nanoparticles and a dispersing agent, wherein imbibing includes wetting the polymer substrate with the dispersion.

According to another embodiment, further to Embodiment 6, imbibing the polymer substrate includes heating the polymer substrate to a first temperature at which a processing aid is volatilized, and wherein heating the metal nanoparticles includes heating the metal nanoparticles to a second temperature to sinter the metal nanoparticles.

According to another embodiment, further to Embodiment 6, the second temperature at which the nanoparticles are sintered is lower than a melting temperature of the polymer substrate.

According to another embodiment, further to Embodiment 6, the first temperature is about 90 degrees Celsius and the second temperature is about 300 degrees Celsius.

According to another embodiment, further to Embodiment 6, the porous structure defines an interior surface and the metal coating is positioned on interior surfaces of the polymer substrate to define a continuous metal coating on the porous structure, including the interior surface, of the polymer substrate.

According to another embodiment, further to Embodiment 6, the metal coating is selected from one of a platinum coating, iridium coating, ruthenium coating, palladium coating, gold coating, silver coating, copper coating, nickel coating, indium coating, combinations thereof, alloys thereof, including alloys with transition metals, and/or oxides thereof.

According to another embodiment, further to Embodiment 6, the polymer substrate is a membrane.

According to another embodiment, further to Embodiment 6, the polymer substrate is selected from one of expanded polytetrafluoroethylene and expanded polyethylene.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIGS. 1A-1C are SEM images showing the microstructure of a conformal-gold-on-ePTFE (“CG/ePTFE”) composite of an Example, in accordance with certain embodiments of the present disclosure;

FIG. 2 is a schematic illustrative diagram of a membrane electrode assembly, in accordance with certain embodiments of the present disclosure;

FIG. 3 is a schematic view of an apparatus used to measure sheet resistance, in accordance with certain embodiments of the present disclosure;

FIG. 4 depicts an illustrative flow diagram showing a method 400 for forming a composite material, in accordance with certain embodiments of the present disclosure;

FIGS. 5A-5C depict a wet flex particulation durability test method, in accordance with certain embodiments of the present disclosure;

FIGS. 6A-6C are SEM images showing the microstructure of a conformal-silver-on-ePTFE (“CS/ePTFE”) composite of an Example, in accordance with certain embodiments of the present disclosure.

### DETAILED DESCRIPTION

Persons skilled in the art will readily appreciate that various aspects of the present disclosure can be realized by any number of methods and apparatuses configured to perform the intended functions. It should also be noted that the accompanying drawing figures referred to herein are not necessarily drawn to scale, but may be exaggerated to illustrate various aspects of the present disclosure, and in that regard, the drawing figures should not be construed as limiting.

This disclosure is not meant to be read in a restrictive manner. For example, the terminology used in the application should be read broadly in the context of the meaning those in the field would attribute such terminology.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

As used herein, the term “conductive” means “electrically conductive” except where otherwise indicated.

As used herein, the term “porous” is used to describe a structure having voids (e.g., pores) and a solid matrix. The pores each have a pore volume, and the plurality of pores define the total pore volume of a microporous polymer substrate. The solid matrix refers to the solid portion of the microporous polymer substrate, excluding its pore volume.

As used herein, the term “microporous” is used to describe a material that includes pores of a single pore size or of a distribution of pore sizes. The average or median pore size may be from about 0.05 μm to about 50 μm, or from about 0.1 to about 50 μm, or from about 0.1 to about 30 μm, or from about 0.2 to about 60 μm, or from about 0.5 to about 50 μm, or any intermediate range or value encompassed within these ranges. It is understood that the microporous material may include individual pores that fall outside of this average size range, including some macropores. The microporous material may have a characteristic or nominal pore size characterized by bubble point analysis or another suitable test, as set forth below. The average pore size of the material may, for example, be characterized by the mean flow pore size determined by capillary flow porometry.

As used herein, the term “interior surfaces” refers to surfaces of the features (e.g., nodes, fibrils, fibers, bundles of fibers) that define the walls of the pores of a microporous substrate.

As used herein, the term “conformal” refers to a coating layer which coats a microporous substrate, such that the coating layer substantially exhibits the surface contour of the microporous substrate, including exterior surfaces of the substrate, and interior surface features (e.g., nodes, fibrils, fibers, bundles of fibers).

As used herein, the term “continuous coating” refers to a coating layer which is substantially electrically continuous along the surfaces of a microporous substrate (including exterior and interior surfaces). A continuous coating may exhibit high conductivity in the through-plane and in-plane directions relative to the microporous substrate.

As used herein, the term “imbibing” refers to a process of depositing a material within the pores of a microporous substrate using a liquid carrier, but not substantially incorporating the imbibed material into the matrix of the microporous substrate, such that the microporous substrate remains largely intact.

As used herein, the phrase “electrically conductive material” refers to a material that transports electrons with a low resistance such that the electrical resistance of the material will not render it unfit for use in the desired application. In practice, this phrase typically means a resistivity lower than about 1×10⁻³ ohm×cm.

As used herein, the phrases “electrically non-conductive material” and “electrically insulating material” refer to a material with a high resistance such that the electrical conductance of the material will not render it unfit for use in the desired application. In practice, these phrases typically mean a resistivity higher than about 1×10⁸ ohm×cm.

As used herein, “wetting” refers to the spreading of a fluid on a substrate. In the case of a microporous substrate, wetting refers also to infiltration of the fluid into the pores.

As used herein, “de-wetting” describes the withdrawal of fluid from a previously wetted region of a substrate (e.g., a droplet formation where a thin film of liquid ruptures on a substrate).

The device and methods shown and described herein are provided as an example of the various features of the devices and methods and, although the combination of those illustrated features is clearly within the scope of invention, that example and its illustration is not meant to suggest the inventive concepts provided herein are limited from fewer features, additional features, or alternative features to one or more of those features are described with respect to different examples.

The articles, devices, and methods discussed herein generally relate to a microporous substrate (e.g., an expanded polymer membrane) coated with sintered metal nanoparticles. The metal nanoparticles form a durable, metal coating on the microporous substrate, for example, by sintering the metal nanoparticles. According to some embodiments, the sintered, metal nanoparticles form a conformal coating on the microporous substrate, including exterior and interior surfaces of the microporous substrate. In some embodiments, the sintered, metal nanoparticles form a continuous, conformal coating on the microporous substrate, including exterior and interior surfaces. The various features and methods of achieving such results are discussed throughout. The articles discussed herein maintain microporous characteristics after the continuous, conformal coating is applied to the microporous substrate.

In one embodiment, a composite material includes a polymer substrate having a microporous structure, and a conformal coating disposed about a surface of the polymer substrate, wherein the conformal coating is formed of metal nanoparticles that are sintered.

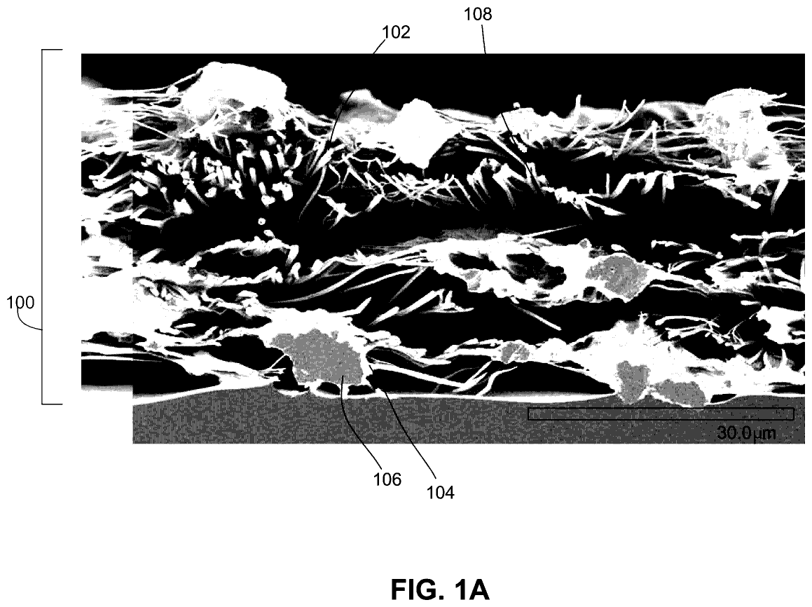

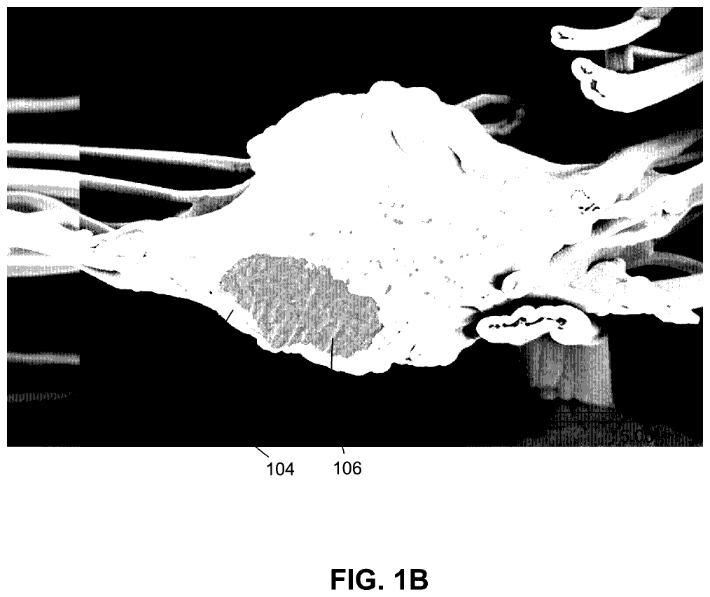

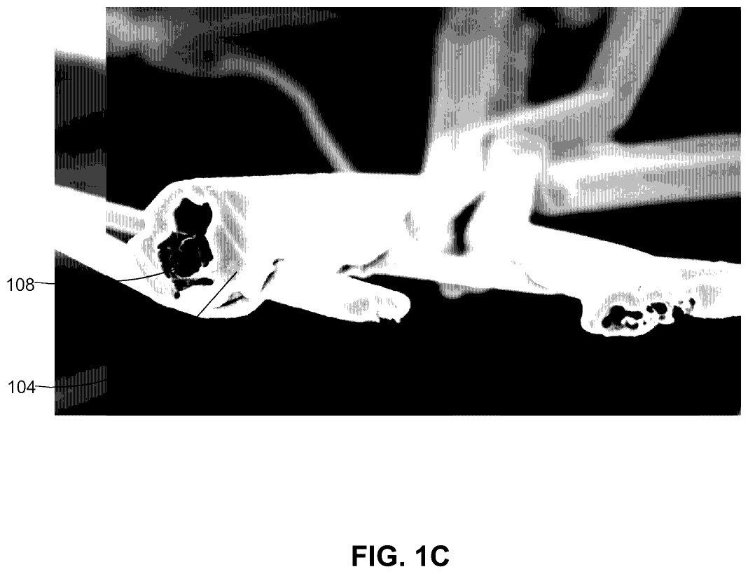

Referring now to FIGS. 1A-1C, a composite material 100 is illustrated. FIGS. 1A-1C provide representative SEM images of a sample of the composite material 100. FIG. 1A shows a cross-section of the composite material 100 generally, FIG. 1B shows a cross-section of the composite material 100 at a node of the composite material 100 as defined within the microstructure of the composite material 100, and FIG. 1C shows a cross-section of the composite material 100 at fibrils of the composite material as defined within the microstructure of the composite material 100.

As shown in FIG. 1A, the composite material 100 includes a polymer substrate 102. In some embodiments, the polymer substrate may be porous (e.g., having a plurality of pores). In some embodiments, the polymer substrate may be microporous. In certain embodiments, the polymer substrate 102 may be expanded polytetrafluoroethylene (ePTFE). In certain embodiments, the polymer substrate 102 may be a membrane. In certain embodiments, the membrane may be a synthetic polymer membrane.

According to some embodiments, the polymer substrate 102 may have a first major exterior surface (e.g., a first surface) and a second major exterior surface (e.g., a second surface), which is opposite the first surface. In some embodiments, where the polymer substrate 102 is in the form of a tube, the first and second major exterior surfaces correspond to the inner and outer diameters of the tube. The polymer substrate 102 may have a thickness, which is the distance between the two major exterior surfaces. The plurality of pores have inner surfaces defined by their interfaces with the solid matrix. The inner surface of a pore refers to the surface of the pore which is not on an exterior surface of the substrate. In some embodiments, the polymer substrate 102 may be from about 1 micrometer to about 100 micrometers in thickness.

According to certain embodiments, a microporous polymer substrate as described herein may be a porous polymer structure that may be configured in a variety of forms such as a web (i.e., a long, thin, flexible material supplied in a roll form), a sheet (e.g., a flat sheet), or a tube (e.g., a round tube). In certain embodiments, the porous polymer structure may be thin, flexible, and/or freestanding.

In some embodiments, a microporous polymer substrate (e.g., the polymer substrate 102) may include a continuous layer of material including pores that create passageways extending from the first surface to the second surface (i.e., from one exterior surface of the layer to the opposite exterior surface of the layer). Such passageways may be described as through pores. The pore volume may also include pores that are not through pores (i.e., some pores may not be connected to both exterior surfaces through the pore volume). Such pores that are connected to only one exterior surface may be described as dead-end pores, and such pores that are not connected to either exterior surface may be described as closed-cell pores. In some embodiments, within the pore volume, the pores may be interconnected and may form a continuous porous network. In certain embodiments, within the pore volume, the pores may be isolated from each other. In some embodiments, within the pore volume, there may be any intermediate level of interconnection among the pores.

According to some embodiments, the solid matrix includes a continuous network of interconnected material elements, and the pores may be void spaces between these material elements. According to certain embodiments, the material elements include a wide variety of structural components that form the building blocks of the overall polymer structure. The material elements are not particularly limited, and may include, for example, fibers, bundles of fibers, nodes, and fibrils. In some embodiments, the polymer substrates described herein may have a microstructure including fibers, bundles of fibers, and a plurality of pores, wherein the fibers and bundles of fibers are interconnected, and the plurality of pores are void spaces between the fibers and bundles of fibers. In certain embodiments, the polymer substrates described herein may have a microstructure including nodes, fibrils, and a plurality of, wherein the nodes are interconnected by the fibrils, and the plurality of pores are void spaces between the nodes and fibrils.

In some embodiments, the polymer substrates described herein may support and mechanically reinforce composite materials, improving its structural integrity and durability. In some embodiments, the polymer substrates may enable the composite membrane to be thin and/or of large area while retaining handleability and other desirable properties. In certain embodiments, the polymer substrates are thermally, chemically, and/or electrochemically stable in the environment in which the composite membrane is to be used. In certain embodiments, the polymer substrates may be tolerant of any manufacturing steps required in the production of the composite membrane, and/or in the subsequent storage, shipping, and handling of the composite membrane.

In certain embodiments, the polymer substrates described herein may be stable at very high pH (e.g., above about pH 10, or above about pH 11, or above about pH 12, or above about pH 13, or above about pH 14). In some embodiments, the polymer substrates may be stable at very low pH (e.g., below about pH 5, or below about pH 4, or below about pH 3, or below about pH 2, or below about pH 1).

According to some embodiments, the polymer substrates described herein may be formed by any suitable method for the intended application. The method of manufacturing the polymer substrates is not particularly limited, and any method known in the art may be used to form the polymer substrates. In some embodiments, suitable processing methods may include roll-to-roll processing, paste processing, gel processing, and expansion. Depending on the method of manufacture, the polymer substrates may have a machine direction (MD) and a transverse direction (TD), wherein the MD is orthogonal to the TD. In certain embodiments, the MD and TD are each orthogonal to the thickness direction. In some embodiments, for example when a polymer substrate is in the form of a web, its MD may align with the long direction, and TD may align with the width direction.

According to certain embodiments, the polymer substrates described herein may be formed from any suitable material for the intended application. The material is not particularly limited and any material known in the art may be used to form the polymer substrate. For example, the polymer substrate may include polymeric materials. In some embodiments, the polymeric materials may include a polymer or a mixture of polymers. In some embodiments, the polymeric materials may include a homopolymer or a copolymer. In some embodiments, the polymeric materials may include inorganic polymeric materials and/or organic polymeric materials. In certain embodiments, the polymeric materials may include fluorine and/or other heteroatoms. In certain embodiments, the polymeric materials may include aromatic moieties and/or non-aromatic (e.g., aliphatic or olefinic) moieties. In certain embodiments, the polymeric materials may include side chains and/or functional groups. In some embodiments, the polymeric materials may include a polymer that is fibrillatable (e.g., PTFE).

According to some embodiments, the polymer substrates described herein may be formed from any one selected from a non-fluorinated polymer (e.g., a hydrocarbon polymer), a partially fluorinated polymer, a perfluorinated polymer, and any combination thereof. In some embodiments, the polymer substrates described herein may include polyolefins such as polyethylene (PE) or polypropylene (PP). In some embodiments, the polymer substrates described herein may include any one selected from a polytetrafluoroethylene (PTFE), a polyethylene (PE), or a copolymer of PTFE and PE. In certain embodiments, the polymer substrates described herein may include an expanded polytetrafluoroethylene (ePTFE) or an expanded polyethylene (ePE).

Non-limiting examples of a suitable material for use as the polymer substrate 102 include expanded polytetrafluoroethylene (ePTFE). In at least one embodiment, the polymer substrate 102 is a microporous synthetic polymer membrane, such as a microporous fluoropolymer membrane having a node and fibril microstructure where the nodes are interconnected by the fibrils and the pores are the voids or space located between the nodes and fibrils throughout the polymer substrate. An exemplary node and fibril microstructure is described in U.S. Pat. No. 3,953,566 to Gore. The nodes and fibrils of the microporous microstructure have surfaces that define an interior surface of the polymer substrate.

The polymer substrates described herein may have a volume-specific surface area of greater than about 2.0 m²/cm³, greater than about 4.0 m²/cm³, greater than about 6.0 m²/cm³, greater than about 8.0 m²/cm³, greater than about 10 m²/cm³, greater than about 20 m²/cm³, greater than about 30 m²/cm³, greater than about 40 m²/cm³, greater than about 50 m²/cm³, greater than about 60 m²/cm³, greater than about 70 m²/cm³, greater than about 80 m²/cm³, greater than about 90 m²/cm³, and up to about 100 m²/cm³. Herein, volume-specific surface area is defined on the basis of skeletal volume, not envelope volume.

In some embodiments, the volume-specific surface area is from about 2.0 m²/cm³ to about 100 m²/cm³, or from about 3.0 m²/cm³ to about 90 m²/cm³, or from about 4.0 m²/cm³ to about 80 m²/cm³, or from about 5.0 m²/cm³ to about 70 m²/cm³, or from about 6.0 m²/cm³ to about 60 m²/cm³, or from about 7.0 m²/cm³ to about 50 m²/cm³, or from about 7.5 m²/cm³ to about 40 m²/cm³, or from about 8.0 m²/cm³ to about 30 m²/cm³, or from about 8.5 m²/cm³ to about 20 m²/cm³, or from about 9.0 m²/cm³ to about 10 m²/cm³, or may have a volume-specific surface area in the range of any other range encompassed by these endpoints.

In some embodiments, the volume-specific surface area is from about 2.0 m²/cm³ to about 3.0 m²/cm³, or from about 3.0 m²/cm³ to about 5.0 m²/cm³, or from about 5.0 m²/cm³ to about 10 m²/cm³, or from about 10 m²/cm³ to about 20 m²/cm³, or from about 20 m²/cm³ to about 30 m²/cm³, or from about 30 m²/cm³ to about 40 m²/cm³, or from about 50 m²/cm³ to about 60 m²/cm³, or from about 60 m²/cm³ to about 70 m²/cm³, or from about 70 m²/cm³ to about 80 m²/cm³, or from about 80 m²/cm³ to about 90 m²/cm³, or from about 90 m²/cm³ to about 100 m²/cm³, or may have a volume-specific surface area in the range of any other range encompassed by these endpoints.

In addition, the majority of the fibrils in the polymer substrate have a diameter that is less than about 1.0 μm, or from about 0.1 μm to about 1.0 μm, from about 0.3 μm to about 1.0 μm, from about 0.5 μm to about 1.0 μm, or from about 0.7 μm to about 1.0 μm, or may have a diameter in the range of any other range encompassed by these endpoints. Additionally, the polymer substrates may be thin, having a thickness from about 1 μm to about 100 μm, or from about 1.1 μm to about 75 μm, or from about 1.2 μm to about 50 μm, or from about 1.3 μm to about 35 μm, or from about 1.4 μm to about 25 μm, or from about 1.5 μm to about 10 μm, or from about 1.6 μm to about 5 μm, or from about 1.7 μm to about 4 μm, or from about 1.8 μm to about 3 μm, or may have any other thickness in the range of any other range encompassed by these endpoints.

In some embodiments, the polymer substrate may have a conformal coating disposed about a surface of the polymer substrate, the conformal coating formed of metal nanoparticles that are sintered. In some embodiments, the conformal coating may be disposed about the interior surfaces of the polymer substrate. In certain embodiments, the metal nanoparticles may be sintered. Non-limiting examples of the conformal coating may include metal nanoparticles such as platinum group metals (PGMs, e.g., platinum, iridium, ruthenium, palladium), gold, silver, copper, nickel, indium, combinations thereof, alloys thereof (e.g., alloys including transition metals), and/or oxides thereof.

The composite material 100 may also include a conformal coating 104 formed of sintered metal nanoparticles dispersed about a surface of the polymer substrate 102. The coating 104 may be formed of metal nanoparticles that are sintered.

In some embodiments, for example as shown in FIGS. 1B-1C, the microporous structure defines an interior surface and the conformal coating 104 formed of sintered metal nanoparticles is disposed on interior surfaces of the polymer substrate 102. In certain embodiments, the conformal coating 104 formed of sintered metal nanoparticles is a continuous coating on the surface, including the interior surface, of the polymer substrate 102.

In some instances, the polymer substrate 102 includes a microstructure having a plurality of nodes 106 (for example as shown in FIG. 1B) and fibrils 108 (for example as shown in FIG. 1C). The conformal coating 104 formed of sintered metal nanoparticles is positioned about the nodes 106 and fibrils 108 of the polymer substrate 102.

In certain instances, the conformal coating 104 formed of sintered metal nanoparticles is selected from one of a platinum coating, iridium coating, ruthenium coating, palladium coating, gold coating, silver coating, copper coating, nickel coating, indium coating, combinations thereof, alloys thereof (e.g., alloys including transition metals), and/or oxides thereof.

According to some embodiments, a coated polymer substrate includes a microporous polymer continuously and conformally coated by sintered, metal nanoparticles. In some embodiments, the sintered, metal nanoparticles are coating interior surfaces of the polymer substrate. According to certain embodiments, the polymer substrate includes a node and fibril microstructure, wherein the sintered, metal nanoparticles are coating the nodes and fibrils of the polymer substrate. In certain embodiments, the sintered metal nanoparticles form a continuous, conformal coating on the inner surfaces of the polymer substrate. In some embodiments, the polymer substrate may have microstructures. The microstructures may include, for example, nodes and/or fibrils. In some instances, the thickness of the conformal coating formed on the nodes may be similar to the thickness of the conformal coating formed on the fibrils. In some instances, the thickness of the conformal coating formed on the nodes may be different from the thickness of the conformal coating formed on the fibrils. In some embodiments, the thickness of the conformal coating formed on one node may be substantially similar to the thickness of the conformal coating formed on another node. In some embodiments, the thickness of the conformal coating formed on one fibril may be similar to the thickness of the conformal coating formed on another fibril.

According to the present disclosure, a durable, conformal metal coating may be formed on the interior surfaces and throughout the thickness of a polymer substrate with tortuous pores and low surface energy (e.g., ePTFE) via imbibing and sintering of metal nanoparticles.

One historical impediment to conformal coatings, as discussed above regarding the third aggravating factor in the background, is that it is challenging to produce thin, metal coatings on polymer substrates with high-surface area and low surface-energy (for example, ePTFE). This challenge may be exacerbated when there is a large surface energy mismatch between the coating and the polymer substrate. In general, metals tend to have much higher surface energies than polymers, especially low-surface-energy polymers such as polytetrafluoroethylene (PTFE). As illustrative examples, metals such as gold and platinum have surface energies of approximately 1500 mJ/m² and approximately 2400 mJ/m², respectively, whereas PTFE has a surface energy of approximately 20 mJ/m² (two orders of magnitude lower).

Without wishing to be bound by theory, it is generally understood that surfaces tend toward the lowest energy state, and therefore materials having higher surface energy tend not to “wet” low-energy surfaces, especially those with large surface area. Furthermore, materials with high surface energy will tend to “de-wet” low-surface energy surfaces when possible, and to accumulate or agglomerate in ways that minimize their surface area. It is also generally understood that metal nanoparticles may be sintered at temperatures far below the melting point of the bulk metal. This sintering is thought to occur via melting point depression through, for example, the Gibbs-Thomson effect. Thus, it would be expected that sintering of metal nanoparticles positioned on low-energy surfaces would result in substantial “de-wetting” of metal from the low-energy surface of the target polymer substrate such that the metal nanoparticles accumulate or agglomerate in the available pore space. Furthermore, metal coatings may be expected to have relatively poor adhesion to low-energy surfaces. However, the present disclosure demonstrates articles and methods for preparing those articles that achieved substantially uniform, conformal metal coatings of low-energy surfaces of a polymer substrate. In addition, the conformal coatings were durably attached to the polymer substrate as illustrated by the results of the Wet Flex Particulation test described below. The present disclosure demonstrates embodiments and methods in which metal nanoparticles fused into a relatively thin, dense metal coating that substantially conformed to the interior surfaces of a polymer substrate (e.g., ePTFE), wherein the metal nanoparticles spread out over a relatively large surface area.

The mechanical durability of a metal coating on a polymer substrate (e.g., the adherence of the metal coating to the polymer substrate) may be measured with an in-house Wet Flex Particulation test described in more detail below. In some embodiments, the level of particulation for the conductive coating may be lower than 0.01 wt % of the conductive coating (i.e., corresponding to a retention of the conductive coating greater than 99.99 wt %). In some embodiments, the retention of the conductive coating may be greater than 99.9 wt %. In some embodiments, the retention of the conductive coating may be greater than 99 wt %. In some embodiments, the retention of the conductive coating may be greater than 90 wt %.

Accordingly, the present disclosure relates to providing conformal metal coatings including on interior surfaces of a polymer substrate despite the difficulties associated with e.g., the surface energies and other aggravating factors discussed herein. In some embodiments, metal nanoparticles (e.g., gold) are deposited and treated to form a conformal coating and continuous coating about the polymer substrate. Without wishing to be bound by theory, this is achieved by substantially uniformly delivering metal nanoparticles to the surfaces of a microporous substate and inducing the metal nanoparticles to sinter (e.g., to rapidly sinter) together in the pores of the polymer substrate to form a conformal coating on the surfaces of a polymer substrate (e.g., ePTFE). In some instances, the conformal coating may fully surround microstructural features such as nodes and/or fibrils, which may enhance the durability of the conductive coating (e.g., as measured by a Wet Flex Particulation Test). In some instances, all surfaces of the substrate (including exterior and interior surfaces) are substantially coated by the conformal coating. In some instances, at least a portion of the exterior and interior surfaces of the substrate are coated with the conformal coating.

According to an embodiment as shown in FIGS. 1A-1C, representative SEM images of an example of a conformal-gold-on-ePTFE CG/ePTFE composite are shown. FIG. 1A shows a composite cross-section, FIG. 1B shows its node cross-section, and FIG. 1C shows its fibril cross-section. The CG is visible around the nodes and fibrils of the ePTFE membrane.

In an embodiment, according to cross-sectional SEM images, sintered metal nanoparticles are shown to conform to the surface topography of features of the polymer substrate (e.g., nodes) (see, for example, FIG. 1B). In some embodiments, the fibrils of the polymer substrate are sheathed in the metal nanoparticles around their entire circumference (see, for example, FIG. 1C).

It is understood that the articles and methods described herein may be implemented in various settings. In one non-limiting example, a polymer substrate with conformal coatings of sintered metal nanoparticles may be implemented in an electrochemical cell or a device comprising an electrochemical cell, for example with respect to energy storage and conversion. In one embodiment, the conformally coated polymer substrate may be configured as a component of an electrochemical cell, such as an electrode. In another embodiment, the conformally coated polymer substrate may be configured as a part of a membrane electrode assembly.

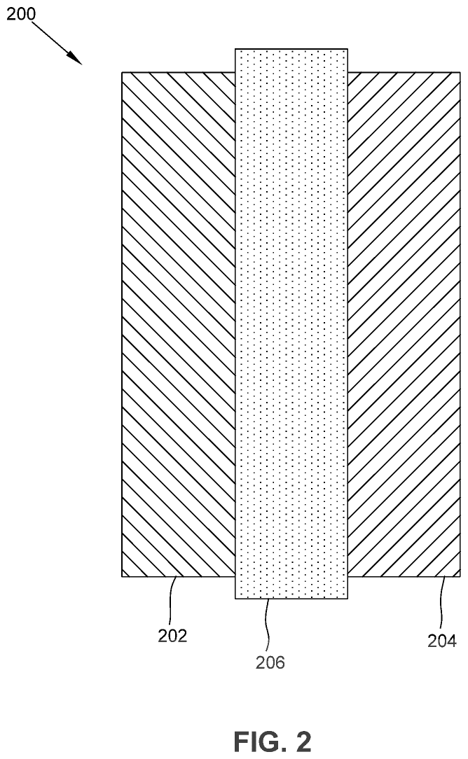

For example, referring now to FIG. 2, a schematic illustrative diagram of a membrane electrode assembly 200 implementing composite materials and/or polymer substrates as described herein. As shown, the membrane electrode assembly 200 may have several layers including a cathode layer 202, an anode layer 204, and a separator layer 206. The membrane electrode assembly 200 may be integrated into a single structure, as shown in FIG. 2, or may be separate structures. In one embodiment, an article may include a separator layer 206, adhered to an electrode in which the electrode includes a polymer substrate with conformal coatings of sintered metal nanoparticles. The membrane electrode assembly may include both electrodes or only one. As will be appreciated by a person of ordinary skill in the art, the size, shape, orientation, compliance, flexibility, and other attributes of the membrane electrode assembly 200 may vary.

In some embodiments, the cathode layer 202 and/or the anode layer 204 may be electrically conductive. In some instances, the cathode layer 202 and/or the anode layer 204 may include catalysts. In some instances, the cathode layer 202 and/or the anode layer 204 may include electrocatalysts. In some instances, the cathode layer 202 may include an electrocatalyst for reduction reactions. In some instances, the anode layer 204 may include an electrocatalyst for oxidation reactions. In some instances, the aforementioned electrocatalysts may have extended surfaces. In such cases, there is interest in preparing conductive materials with specific characteristics such as high catalytic activity, high current density, robust mass transport, high durability, and so forth.

In some embodiments, when the polymer substrate with conformal coatings formed of sintered metal nanoparticles is configured as an electrode, the electrode may be modified to enable ionic conductance. For example, the electrode may be configured to allow the transport of cations and/or anions. In certain embodiments, the electrode may become ionically conductive when it is wetted or swollen by a liquid electrolyte. In certain embodiments, the electrode may include an ion exchange material (e.g., at least one ion exchange polymer). In certain embodiments, the ion exchange material may include a hydrocarbon ion exchange material. In certain embodiments, the ion exchange material may include a fluorocarbon ion exchange material. In certain embodiments, the ion exchange material may include a perfluorocarbon ion exchange material. In certain embodiments, the ion-exchange material may include an anion-exchange material (e.g., an anion exchange polymer). In certain embodiments, the ion-exchange material may include a cation-exchange material (e.g., a cation exchange polymer). In certain embodiments, the ion-exchange material may include a perfluorosulfonic acid. As will be readily understood by one of ordinary skill in the art, the ionic conductance of a porous electrode may be quantified using electrochemical impedance spectroscopy (e.g., modeled using an equivalent circuit incorporating a “transmission line” feature).

When used as a component of an electrochemical cell (e.g., as a component such as an electrode or as a part of a membrane electrode assembly), the conformally coated polymer substrate may have certain advantages compared to conventional materials. According to some embodiments, the membrane electrode assembly 200 may exhibit higher durability compared to a conventional membrane electrode assembly using traditional “ink-based” electrodes using carbon-supported PGM-based catalysts. Also, according to some embodiments, the membrane electrode assembly 200 may exhibit more robust performance (i.e., high performance over a wider operating range) than a conventional membrane electrode assembly.

The separator layer 206 may be located in between the cathode layer 202 and the anode layer 204. In some instances, the separator layer 206 may be an ionically conductive and electrically insulating layer that allows the transport of ions between the anode layer 204 and the cathode layer 202 through the separator layer 206, but forces electrons to travel around an external circuit. In certain embodiments, the separator layer 206 may be an electrochemical separator that becomes ionically conductive when wetted by a liquid electrolyte. The electrochemical separator may be configured to allow the transport of cations and/or anions. In certain embodiments, the separator layer 206 may be an electrochemical separator including an ion-exchange material (e.g., at least one ion exchange polymer). In certain embodiments, the ion exchange material may include a hydrocarbon ion exchange material. In certain embodiments, the ion exchange material may include a fluorocarbon ion exchange material. In certain embodiments, the ion exchange material may include a perfluorocarbon ion exchange material. In certain embodiments, the ion-exchange material may include an anion-exchange material (e.g., an anion exchange polymer). In certain embodiments, the ion-exchange material may include a cation-exchange material (e.g., a cation exchange polymer). In certain embodiments, the ion-exchange material may include a perfluorosulfonic acid. As will be readily understood by one of ordinary skill in the art, the ionic conductance of an electrochemical separator may be quantified using electrochemical impedance spectroscopy (e.g., by examining the real part of the impedance at an appropriately high frequency, such as where the data crosses the x-axis of a Nyquist plot).

In one example of conductive articles, for example as shown in FIG. 2, microporous, electrocatalytic electrodes may be used for energy storage and conversion applications such as fuel cells and/or electrolyzers. In some instances, the fuel cell may be a proton exchange membrane fuel cell (PEMFC). In some instances, the electrolyzer may be a proton exchange membrane water electrolyzer (PEMWE).

According to certain embodiments, the conformally coated polymer substrate has a ratio of the volume of the conformal coating to the volume of the pore phase (V_{coat}/Vₚₒᵣₑ) in the range from about 0.001 to about 1.0, or from about 0.01 to about 0.9, or from about 0.02 to about 0.8, or from about 0.03 to about 0.7, or from about 0.04 to about 0.6, or from about 0.05 to about 0.5, or from about 0.06 to about 0.4, or from about 0.07 to about 0.3, or from about 0.08 to about 0.25, or from about 0.09 to about 0.2, or from about 0.1 to about 0.15, 0.001 to about 0.01, or from about 0.01 to about 0.02, or from about 0.02 to about 0.03, or from about 0.03 to about 0.04, or from about 0.04 to about 0.06, or from about 0.06 to about 0.8, or from about 0.08 to about 0.1, or from about 0.1 to about 0.2, or from about 0.2 to about 0.3, or from about 0.3 to about 0.4, or from about 0.4 to about 0.5, or from about 0.5 to about 0.6, or from about 0.6 to about 0.7, or from about 0.7 to about 0.8, or from about 0.8 to about 0.9, or from about 0.9 to about 1.0, or may have a ratio in the range of any other range encompassed by these endpoints.

According to some embodiments, the conformally coated polymer substrate has a porosity of from about 25 vol % to about 95 vol %, or from about 30 vol % to about 94 vol %, or from about 35 vol % to about 93 vol %, or from about 40 vol % to about 92 vol %, or from about 45 vol % to about 91 vol %, or from about 50 vol % to about 90 vol %, or may have a porosity in the range of any other range encompassed by these endpoints. In an exemplary embodiment, the conformally coated polymer substrate has a porosity of from about 55% to about 95%.

The challenge of quantitatively characterizing the pore size of porous materials with complex or irregular pore geometries is well-known. Pore size in this case may be considered a population property that is inherently polydisperse, and may be described by a pore size distribution. A variety of standard evaluation methods are available to those of ordinary skill in the art, such as quantitative image analysis, BET/BJH analysis, capillary flow porometry (including bubble point analysis), and liquid/liquid porometry. Each of these quantification methods makes simplifying assumptions about the pore geometry. Most of these quantification methods produce a pore size distribution from which characteristic pore size (e.g., pore diameter, d) parameters may be extracted, for example, a median or mode pore size (e.g., via BET/BJH analysis), or the largest through-pore (e.g., via bubble point determination). In some embodiments, the mean flow pore size may be determined using capillary flow porometry.

Similarly, the challenge of characterizing the particle size (e.g., the average or median particle diameter, D) is also complex and well-known to those of ordinary skill in the art. A variety of standard tools are available, such as dynamic light scattering, in which case care must be taken to prevent agglomeration from skewing the data. Another method used to determine particle size is direct microscopy of the nanoparticles prior to sintering or when the conformal coating itself has undergone only minimal sintering such that the initial particle size is still evident. Alternatively, the specific surface area (SSA, in units of m²/g, as measured by BET) of unsintered or minimally sintered particles may be measured, and if the density of the particles (p) is known or measured (e.g., by helium pycnometry), then a representative spherical particle size may be calculated using, for example, the standard equations for the volume (Vsphere) and area (Asphere) of a sphere based on its diameter (D). The relevant equations are as follows:

$${A}_{sphere} = π {D}^{2}$$

$${V}_{sphere} = \frac{π {D}^{3}}{6}$$

$$SSA = \frac{π {D}^{2}}{ρ ( \frac{π {D}^{3}}{6} )} = \frac{6}{ρ D}$$

$$D = \frac{6}{( SSA ) ρ}$$

According to some embodiments, the polymer substrate prior to coating or the conformally coated polymer substrate has a characteristic pore size (e.g., a volume-average pore size as determined by quantitative image analysis or a mean flow pore size as determined by capillary flow porometry) that is substantially larger than the characteristic particle size (e.g., the volume-average particle diameter) of the nanoparticles used to produce the conformal coating. For example, the aforementioned pore size may be at least about 2× larger, at least about 3× larger, at least about 4× larger, at least about 5× larger, at least about 10× larger, at least about 20× larger, at least about 30× larger, at least about 40× larger, at least about 50× larger, at least about 100× larger, at least about 200× larger, at least about 300× larger, at least about 400× larger, at least about 500× larger, at least about 1000× larger, at least about 2000× larger, at least about 3000× larger, at least about 4000× larger, at least about 5000× larger, at least about 10,000× larger, or at least about 100,000× larger. In some embodiments, the aforementioned pore size may be from about 2× larger to about 100,000× larger, or may be in the range of any other range encompassed by these endpoints.

According to some embodiments, the conformally coated polymer substrate has a mass/area of from about 1 g/m² to about 100 g/m², or from about 2 g/m² to about 90 g/m², or from about 3 g/m² to about 85 g/m², or from about 4 g/m² to about 80 g/m², or from about 5 g/m² to about 75 g/m², or from about 6 g/m² to about 70 g/m², or from about 7 g/m² to about 65 g/m², or from about 8 g/m² to about 60 g/m², or from about 9 g/m² to about 50 g/m², or from about 10 g/m² to about 50 g/m², or from about 15 g/m² to about 50 g/m², or from about 1 g/m² to about 5 g/m², or from about 5 g/m² to about 10 g/m², or from about 10 g/m² to about 15 g/m², or from about 15 g/m² to about 20 g/m², or from about 20 g/m² to about 30 g/m², or from about 30 g/m² to about 40 g/m², or from about 40 g/m² to about 50 g/m², or from about 50 g/m² to about 60 g/m², or from about 60 g/m² to about 70 g/m², or from about 70 g/m² to about 80 g/m², or from about 80 g/m² to about 90 g/m², or from about 90 g/m² to about 100 g/m², or may have a mass/area in the range of any other range encompassed by these endpoints. In some embodiments, the conformally coated polymer substrate has a mass/area of about 15 g/m², or about 20 g/m², or about 46 g/m².

According to some embodiments, the conformally coated polymer substrate may have sheet resistance of from about 0.1 ohms/square to about 0.5 ohms/square, or from about 0.11 ohms/square to about 0.49 ohms/square, or from about 0.12 ohms/square to about 0.48 ohms/square, or from about 0.13 ohms/square to about 0.47 ohms/square, or from about 0.14 ohms/square to about 0.46 ohms/square, or from about 0.15 ohms/square to about 0.45 ohms/square, or from about 0.16 ohms/square to about 0.44 ohms/square, or from about 0.17 ohms/square to about 0.43 ohms/square, or from about 0.18 ohms/square to about 0.42 ohms/square, or from about 0.19 ohms/square to about 0.41 ohms/square, or from about 0.2 ohms/square to about 0.4 ohms/square.

According to some embodiments, the conformally coated polymer substrate may have sheet resistance of from about 0.5 ohms/square to about 1.0 ohms/square, or from about 0.51 ohms/square to about 0.99 ohms/square, or from about 0.52 ohms/square to about 0.98 ohms/square, or from about 0.53 ohms/square to about 0.97 ohms/square, or from about 0.54 ohms/square to about 0.96 ohms/square, or from about 0.55 ohms/square to about 0.95 ohms/square, or from about 0.56 ohms/square to about 0.94 ohms/square, or from about 0.57 ohms/square to about 0.93 ohms/square, or from about 0.58 ohms/square to about 0.92 ohms/square, or from about 0.59 ohms/square to about 0.91 ohms/square, or from about 0.6 ohms/square to about 0.9 ohms/square, or from about 0.7 ohms/square to about 0.8 ohms/square.

In some embodiments, a polymer substrate includes a microporous membrane having a continuous and conformal coating of metal nanoparticles throughout the entire thickness of the microporous membrane. In certain embodiments, the sheet resistance measured on one side of a composite sheet will be within from about 1% to about 30%, or from about 5% to about 25%, or from about 10% to about 20%, or from about 11% to about 19%, or from about 12% to about 18%, or from about 13% to about 17%, or from about 14% to about 16%, of the sheet resistance measured on the other side. In one embodiment, the sheet resistance measured on one side of a composite sheet will be within about 15% of the sheet resistance measured on the other side.

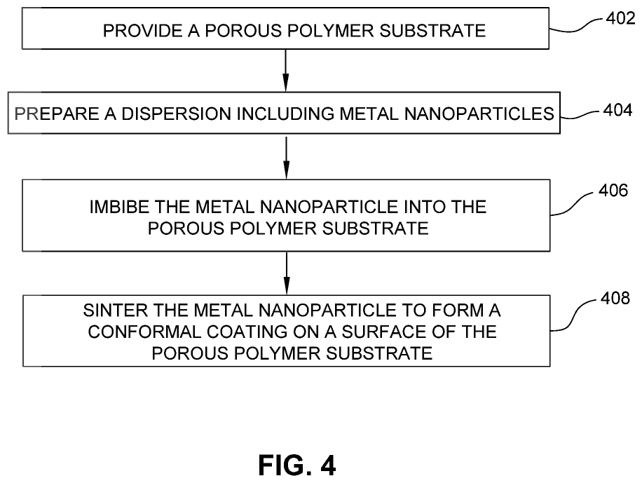

FIG. 4 depicts an illustrative flow diagram showing a method 400 for forming a composite material, in accordance with certain embodiments of the present disclosure. This diagram is merely an example. One of ordinary skill in the art would recognize many variations, alternatives, and modifications. The method 400 for forming a composite material includes processes 402, 404, 406, and 408. Although the above has been shown using a selected group of processes for the method 400 for forming a composite material, there can be many alternatives, modifications, and variations. For example, some of the processes may be expanded and/or combined. Other processes may be inserted into those noted above. Depending upon the embodiment, the sequence of processes may be interchanged with others replaced. Further details of these processes are found throughout the present disclosure.

According to some embodiments, at process 402, the method 400 includes providing a polymer substrate having a microporous structure. In some embodiments, the polymer substrate may be selected from one of expanded polytetrafluoroethylene and expanded polyethylene. In certain embodiments, the polymer substrate is a membrane. In some instances, the polymer substrate includes a microporous structure having nodes and fibrils defining an interior surface.

According to certain embodiments, at process 404, the method 400 includes preparing the dispersion including the metal nanoparticles in a liquid carrier. The liquid carrier may be considered a processing aid. In some instances, the liquid carrier may be organic and/or aqueous. The dispersion may also include other processing aids, e.g., a dispersing agent such that the metal nanoparticles are stably dispersed in the solvent. Non-limiting examples of dispersing agents include oleylamine and polyvinylpyrrolidone.

In some embodiments, at process 406, the method 400 includes imbibing the polymer substrate with a solution including metal nanoparticles. In some embodiments, process 406 may include substantially uniformly delivering metal nanoparticles to the surfaces of a microporous substate. In some embodiments, process 406 may include delivering metal nanoparticles substantially or completely through the bulk of the material. In certain embodiments, process 406 includes restraining the polymer substrate to substantially prevent dimensional changes.

At process 408, the method 400 includes heating the polymer substrate to sinter the metal nanoparticles to form a metal coating on a surface of the polymer substrate. In general, the temperature required for sintering depends on the composition of the nanoparticle (e.g., which metal or metals are included), the size of the nanoparticle, and the sintering time. In general, metal nanoparticles have different melting temperature compared to the same metal in non-nanoparticle form. Metal nanoparticles tend to have lower melting temperatures compared to the same metal having larger particle sizes. In general, longer sintering times enable the use of lower sintering temperatures.

Process 408 may include heating the polymer substrate to a first temperature at which the liquid carrier evaporates and the metal nanoparticles are deposited about the surface of the polymer substrate, and to a second temperature at which the nanoparticles are sintered. The first temperature may be controlled such that processing aids such as the liquid carrier and the dispersing agent (if any) are volatilized, and the metal nanoparticles are deposited about the surface of the polymer substrate.

In certain embodiments, the second temperature at which the nanoparticles are sintered is lower than a melting temperature of the polymer substrate. The second temperature at which the nanoparticles are sintered being lower than the melting temperature of the polymer substrate substantially preserves the structure of the microporous substrate during formation. In an exemplary embodiment, the first temperature is about 90 degrees Celsius and the second temperature is about 300 degrees Celsius. In certain embodiments, the polymer substrate is restrained during Process 408 to substantially prevent dimensional changes.

The formed metal coating may be disposed on interior surfaces of the polymer substrate to define a continuous metal coating on the microporous structure, including the interior surface, of the polymer substrate. In some embodiments, the metal coating is selected from one of a platinum coating, iridium coating, ruthenium coating, palladium coating, gold coating, silver coating, copper coating, nickel coating, indium coating, combinations thereof, alloys thereof (e.g., alloys including transition metals), and/or oxides thereof.

### Test Methods

It should be understood that although certain methods and equipment are described below, other methods or equipment determined suitable by one of ordinary skill in the art may be alternatively utilized.

### Non-Contact Thickness

Non-contact thickness was measured using a laser micrometer (Keyence Model No. LS-7010, Mechelen, Belgium) using the following technique. A metal cylinder was aligned between the laser micrometer source and the laser micrometer receiver such that a first shadow of the top of the cylinder was projected onto the receiver. The position of the first shadow was then set as the “zero” reading of the laser micrometer. A single layer of test article was then draped over the surface of the metal cylinder without overlap and without wrinkles, which projected a second shadow onto the receiver. The laser micrometer then indicated the change in the position between the first and the second shadows as the thickness of the sample. Each thickness was measured three times and averaged for each sample.

### Bubble Point

Bubble point pressures were measured according to ASTM F31 6-03 using a Capillary Flow Porometer (Model 3Gzh from Quantachrome Instruments, Boynton Beach, Florida), and using Silwick Silicone Fluid (20.1 dyne/cm; microporous Materials Inc.). The values presented for bubble point pressure are the average of two measurements.

### Matrix Tensile Strength Determination

Samples were cut using an ASTM D412-Dogbone F. Where the sample includes an ePTFE membrane, the “machine direction” is in the direction of the extrusion and the “transverse direction” is perpendicular to this. The sample was placed on a cutting table such that the sample was free from wrinkles in the area in which the sample was to be cut. A die was then placed on the sample such that its long axis was parallel to the direction that would be tested. Once the die was aligned, pressure was applied to cut through the sample. Upon removal of the pressure, the Dogbone sample was inspected to ensure it was free from edge defects which may impact the tensile testing. At least 3 samples in the machine direction and three samples in the transverse direction were prepared in this manner. Once the Dogbone samples were prepared, they were measured to determine their mass using a Mettler Toledo scale model AG204.

Tensile break load was measured using an INSTRON® 5500R (Illinois Tool Works Inc., Norwood, MA) tensile test machine equipped with a rubber coated face plate and a serrated face plate such that each end of the sample was held between one rubber coated plate and one serrated plate. The pressure that was applied to the grip plates was approximately 552 kPa. The gauge length between the grips was set at 58.9 mm and the crosshead speed (pulling speed) was set to a speed of 508 mm/min. A 500 N load cell was used to carry out these measurements and data was collected at a rate of 50 points/sec. The laboratory temperature was between 2° and 22.2° C. to ensure comparable results. If the sample broke at the grip interface, the data was discarded. At least 3 samples were successfully pulled (no slipping out of or breaking at the grips) in order to characterize a material in a given direction (e.g., machine direction or transverse direction).

### Kawabata Flexibility Measurement

The low force bending behavior was measured using a Kawabata Pure Bending Tester (KES-FB2-Auto-A; Kato Tech Co. LTD, Kyoto, Japan). The sample was cut to a width of 7 cm. The machine sensitivity was set to 10. The machine automatically tightened the grips and bent the sample to a curvature of 2.5 cm⁻¹ in both directions while recording the applied load. The B-mean value reported is the average of the bending stiffness of the laminated sample when it was bent between 0.5 and 1.5 cm⁻¹ and −0.5 and −1.5 cm⁻¹. The bending stiffness is reported in grams force cm²/cm.

### ATEQ Airflow

ATEQ Airflow is a test method for measuring laminar volumetric flow rates of air through membrane samples. For each membrane, a sample was clamped between two plates in a manner that seals an area of 2.99 cm² across the flow pathway. An ATEQ® (ATEQ Corp., Livonia, MI) Premier D Compact Flow Tester was used to measure airflow rate (L/hr) through each membrane sample by challenging it with a differential air pressure of 1.2 kPa (12 mbar) through the membrane.

### Gurley Airflow

The Gurley air flow test measures the time in seconds for 100 cm³ of air to flow through 1 in² (˜6.45 cm²) sample at 0.177 psi (˜1.22 kPa) of water pressure. The samples were measured in a GURLEY™ Densometer and Smoothness Tester Model 4340 (Gurley Precision Instruments, Troy, NY). The values reported are an average of 3 measurements and are in the units of seconds.

### Capillary Flow Porometry (CFP) Test

Measurements were made using a Quantachrome Porometer 3G zH. The wetting fluid was silicone oil with a nominal surface tension of 19.78 dyne/cm. The pressure range was 0.255 psig to 394 psig. The sample size was 10 mm in diameter.

### Wet Flex Particulation Test

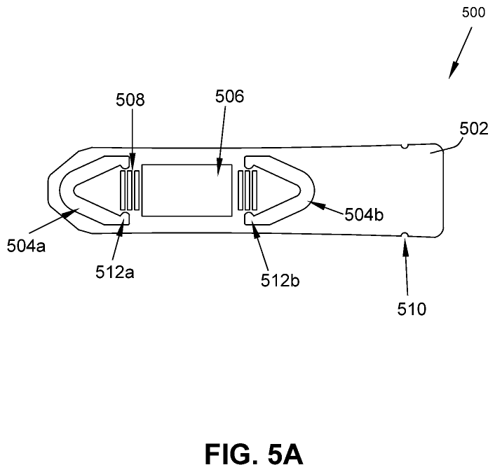

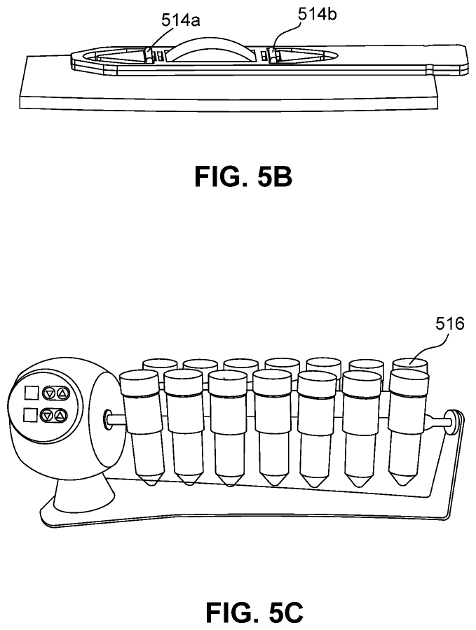

This durability test was developed to evaluate the tendency of the composite materials to shed particles. For the test to be effective, the samples must have sufficiently low bending stiffness to enable full flexural motion under the test conditions. To perform the test, a 2.125″×0.5″ sample was cut from the composite material. The sample was loaded into a test fixture 500 by sandwiching it between two pieces of engineering plastic cut to the shape shown in FIG. 5A. The body 502 of the test fixture includes cut-outs 504a and 504b to enable o-ring installation, a window 506 to allow flexing of sample, ablated grooves 508 to improve sample purchase, locations 510 for o-ring that establishes interference fit in centrifuge tube, and locations 512a and 512b for o-rings to firmly secure the sample.

The sample was loaded with a controlled amount of slack and held in place by o-rings 514a and 514b as shown in FIG. 5B. For scale, the size of the window that allows flexing of the sample is 24.5 mm long×14.1 mm wide×2.7 mm thick. The test fixtures containing the samples were then loaded into standard, 50 mL centrifuge tubes, which were then filled with 40 mL of isopropanol (hereafter, the “test fluid”). Isopropanol was chosen because it readily wet the samples being tested, it was reasonably inert with respect to the samples being tested (e.g., negligible corrosion or dissolution of the samples was expected), and the viscosity was low enough to enable the desired fluid mechanics in the tubes, as described below. Alternative test fluids may be chosen depending on the needs of the samples being tested and the target application. The centrifuge tubes were then capped and taped closed to prevent leakage.

As shown in FIG. 5C, the centrifuge tubes 516 were then loaded into an Intelli-Mixer (#RM-2L) such that the plane of the test fixture was parallel to the axis of rotation. This orientation enables flexing of the sample. The Intelli-Mixer was set to rock the samples +/−99 degrees at 20 rpm for the desired time (typically 1-7 days). Each time the samples rocked, they also flexed due to the fluid dynamics inside the tube. Flexing means the slack in the sample switched from one side of the test fixture to the other. After rocking for the desired time, the liquid in the tube was extracted using a pipet and analyzed using inductively coupled plasma mass spectrometry (ICP-MS) to check for the presence of metal that may have been shed from the composite material.

### Sheet Resistance

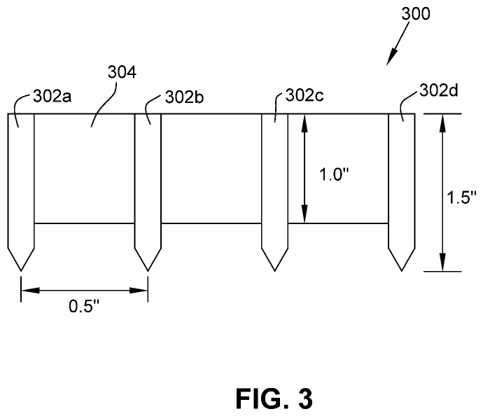

A 2.125″×0.5″ sample was die cut from the sheet of material to be tested. The sample was placed flat on a closed cell silicone sponge sheet (½ inch thick, Bellofoam #7704). The resistance was measured with a Keithley 2750 Digital Multimeter, utilizing a 4-point probe 300 as shown in FIG. 3. The probe 300 was made of gold-plated stainless steel. Each of the 4 probes 302a-d has a width of about 1.2 inches and a length of about 1.5 inches. The 4 probes 402a-d have an average distance of about 0.5 inches from each other, with PTFE spacers 304 connecting them.

The 4-point probe 300 was connected to the Multimeter in the standard 4-point probe configuration (i.e., with the voltage sense leads on the two innermost terminals and the input leads on the two outermost terminals). After gently placing the 4-point probe 300 on the sample to be measured, a 330-gram weight was placed on top of the probe 300 to ensure the probe 300 made reliable, uniform contact with the sample. Care was taken to ensure adequate contact between the probe 300 and the conductive phase of the sample. The weight was insulated with a plastic sheet to ensure it did not short-circuit the probe 300. The Keithley Multimeter was operated in 4-point probe mode with “OCOMP” 4-wire offset compensation enabled. For each measurement, the system was allowed to stabilize for approximately 10 seconds before the resistance value was recorded. The data were reported in units of ohms per square area.

### Example 1: Preparation of Conformal Gold/ePTFE Composite

This example describes the preparation of an ePTFE membrane composite incorporated with a conformal gold coating (“CG/ePTFE composite”).

A first ePTFE membrane (the “target membrane”) (3-5 g/m² mass/area; 1.5 psi bubble point; 92 μm non-contact thickness; W.L. Gore & Associates) was restrained in a 4″ diameter metal hoop and tensioned by hand to remove wrinkles. A second ePTFE membrane (the “portal membrane”) (3-5 g/m² mass/area; 40 psi bubble point; 18 μm non-contact thickness; W.L. Gore & Associates) was restrained in a 6″ diameter metal hoop and tensioned by hand to remove wrinkles. The portal membrane was placed on top of the target membrane so that the two membranes were in physical contact and approximately concentric. 0.75 mL of a gold nanoparticle ink (#UTDAu60X; UTDots, Inc.) was pipetted onto the surface of the portal membrane and spread evenly using a disposable pipet bulb, until the imbibing solution had fully wetted both the portal membrane and the target membrane (<30 seconds). Excess ink was removed by wiping the upper surface of the portal membrane with a lint-free cloth. The two imbibed membranes were then separated by separating their respective hoops. The portal membrane was discarded. Then, the target membrane was dried using a heat gun set to 93° C., and then heated in a standard convection oven at 300° C. for one hour. The result was a CG/ePTFE composite.

The CG/ePTFE composite had a mass/area of 46 g/m² and a sheet resistance of about 0.2-0.4 ohms/square, according to 4-point probe Sheet Resistance test method described above and shown in FIG. 3. To demonstrate that the metal was continuously and conformally coated throughout the entire thickness of the target membrane, the composite's sheet resistance was approximately the same (specifically, within about 15% of the less resistive surface) whether measured on the top or bottom surface.

The samples were stress-tested using the “Wet Flex Particulation Test” for 7 days. Inductively coupled plasma (ICP) analysis of the test fluid showed no detectable gold for either sample (i.e., any gold present was at a level below the detection threshold of the instrument), corresponding to a minimum metal retention of >99.99 wt %.

### Example 2: Preparation of Conformal Silver/ePTFE Composite

This example describes the preparation of an ePTFE membrane composite incorporated with a conformal silver coating (“CS/ePTFE composite”).

A first ePTFE membrane (the “target membrane”) (3-5 g/m² mass/area; 1.5 psi bubble point; 92 μm non-contact thickness; W.L. Gore & Associates) was restrained in a 4″ diameter metal hoop and tensioned by hand to remove wrinkles. A second ePTFE membrane (the “portal membrane”) (3-5 g/m² mass/area; 40 psi bubble point; 18 μm non-contact thickness; W.L. Gore & Associates) was restrained in a 6″ diameter metal hoop and tensioned by hand to remove wrinkles. The portal membrane was placed on top of the target membrane so that the two membranes were in physical contact and approximately concentric. A mixture was prepared using 0.39 g of a silver nanoparticle ink (#UTDAg60X; UTDots, Inc.) and 0.58 g of xylene. About 1 mL of this mixture was pipetted onto the surface of the portal membrane and spread evenly using a disposable pipet bulb, until the imbibing solution had fully wetted both the portal membrane and the target membrane (<30 seconds). Excess ink was removed by wiping the upper surface of the portal membrane with a lint-free cloth. The two imbibed membranes were then separated by separating their respective hoops. The portal membrane was discarded. Then, the target membrane was dried using a heat gun set to 93° C., and then heated in a standard convection oven at 200° C. for one hour. The result was a CS/ePTFE composite.

The CS/ePTFE composite had a mass/area of 15.6 g/m² and a sheet resistance of about 0.7-0.8 ohms/square, according to 4-point probe Sheet Resistance test method described above and shown in FIG. 3. To demonstrate that the metal was continuously and conformally coated throughout the entire thickness of the target membrane, the composite's sheet resistance was approximately the same (specifically, within about 15% of the less resistive surface) whether measured on the top or bottom surface.

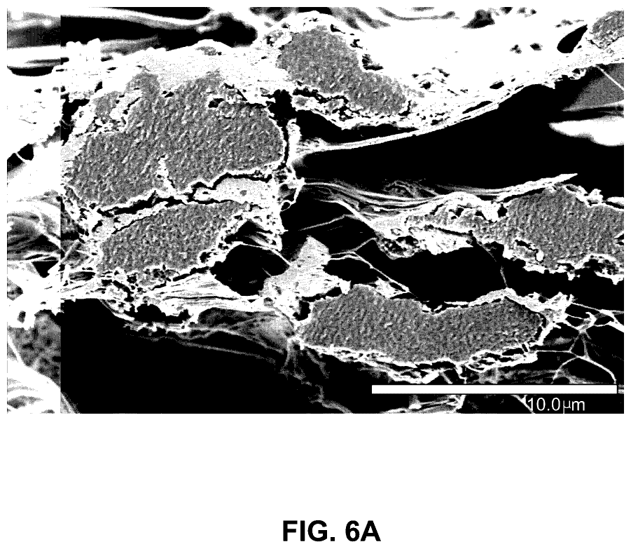

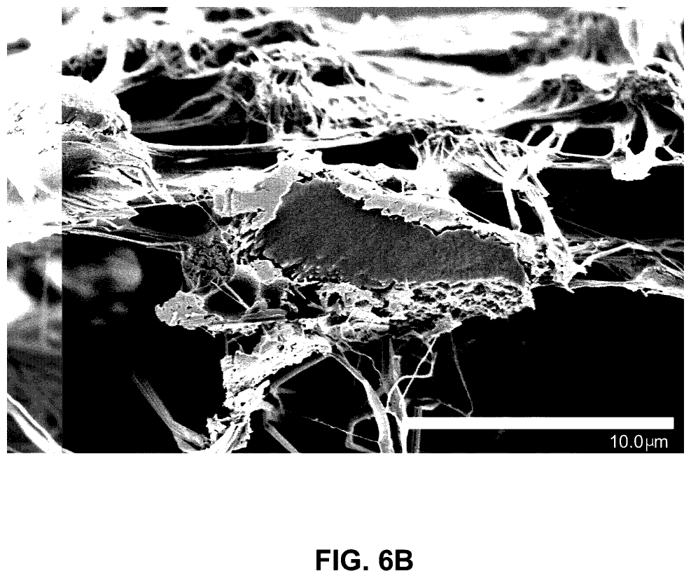

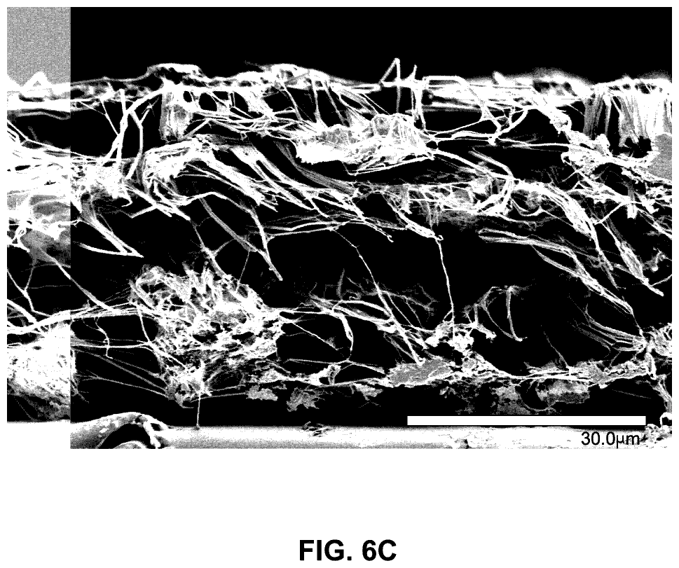

FIGS. 6A-6C are representative SEM images showing the microstructure of the CS/ePTFE composite of Example 2. FIGS. 6A-6B show cross-section of the CS/ePTFE composite at various nodes of the material as defined within the microstructure of the composite, and FIG. 6C shows a cross-section of the CS/ePTFE composite material generally.

As shown, the composite material 600 may also include a conformal coating 604 formed of sintered metal nanoparticles dispersed about a surface of the polymer substrate 602. The coating 604 may be formed of metal nanoparticles that are sintered.

In some embodiments, for example as shown in FIGS. 6A-6B, the microporous structure defines an interior surface and the conformal coating 604 formed of sintered metal nanoparticles is disposed on interior surfaces of the polymer substrate 602. In certain embodiments, the conformal coating 604 formed of sintered metal nanoparticles is a continuous coating on the surface, including the interior surface, of the polymer substrate 602.

In some instances, the polymer substrate 602 includes a microstructure having a plurality of nodes 606 (for example as shown in FIGS. 6A-B) and fibrils 608 (for example as shown in FIG. 6C). The conformal coating 604 formed of sintered metal nanoparticles is positioned about the nodes 606 and fibrils 608 of the polymer substrate 602.

As it relates to metallized polymer substrates, the pore phase and the conformal coating formed of sintered metal nanoparticles disposed on the surface of the polymer substrate may be characterized by calculating various volumetric ratios. Based on the characteristics of components as listed in Table 1, and assuming the mass/area of ePTFE is 4 g/m², the ratios may be calculated as follows:

$${V}_{coat} / {V}_{substrate} = 2.2 cc / {m}^{2} / 1.8 cc / {m}^{2} = 1.22$$

$${V}_{pore} / {V}_{substrate} = 31 cc / {m}^{2} / 1.8 cc / {m}^{2} = 17.2$$

$${V}_{coat} / {V}_{pore} = 2.2 cc / {m}^{2} / 31 cc / {m}^{2} = 0.07$$

$${V}_{pore} / {V}_{total} = 31 cc / {m}^{2} / 35 cc / {m}^{2} = 0.89 = 89 vol \% = “ porosity ”$$

TABLE 1
Characteristics of the Gold/ePTFE Composite in Example 1

| | Mass/Area | Skeletal Density | Volume/Area |
|---|---|---|---|
| Component | (g/m²) | (g/cc) | (cc/m²) |
| Substrate (ePTFE) | 3-5 | 2.2 | 1.8 |
| Coating (Gold) | 42 | 19.3 | 2.2 |
| Pore Volume | N/A | N/A | 31 |
| Total | 45-47 | N/A | 35 |

TABLE 2
Characteristics of the Silver/ePTFE Composite in Example 2

| | Mass/Area | Skeletal Density | Volume/Area |
|---|---|---|---|
| Component | (g/m²) | (g/cc) | (cc/m²) |
| Substrate (ePTFE) | 3-5 | 2.2 | 1.8 |
| Coating (Silver) | 11.6 | 10.5 | 1.1 |
| Pore Volume | N/A | N/A | 41.3 |
| Total | 15.6 | N/A | 44.2 |

The invention of this application has been described above both generically and with regard to specific embodiments. It will be apparent to those skilled in the art that various modifications and variations can be made in the embodiments without departing from the scope of the disclosure. Thus, it is intended that the embodiments cover the modifications and variations of this invention provided they come within the scope of the appended claims and their equivalents.

1. A composite material comprising:
a polymer substrate having a porous structure; and
a conformal coating disposed about a surface of the polymer substrate, wherein the conformal coating is formed of metal nanoparticles that are sintered.

2. The composite material of claim 1, wherein the surface includes an interior surface defined by the porous structure, and the conformal coating is disposed on the interior surface of the polymer substrate.

3. The composite material of claim 1, wherein the conformal coating is a continuous coating on the surface, including the interior surface, of the polymer substrate.

4. The composite material of claim 1, wherein the porous structure of the polymer substrate includes nodes and/or fibrils, wherein the conformal coating is positioned about the nodes and/or fibrils of the polymer substrate.

5. The composite material of claim 1, wherein the porous structure of the polymer substrate is microporous.

6. The composite material of claim 1, wherein the conformal coating is selected from one of a platinum coating, iridium coating, ruthenium coating, palladium coating, gold coating, silver coating, copper coating, nickel coating, indium coating, combinations thereof, alloys thereof, including alloys with transition metals, and/or oxides thereof.

7. The composite material of claim 1, wherein the polymer substrate is a membrane; or
where the polymer substrate is expanded polytetrafluoroethylene; or
wherein the composite material is about 1 micrometer to about 100 micrometers in thickness; or
wherein the composite material has a ratio of the volume of the conformal coating to the volume of the pore phase from 0.001 to 1.0; or
where the composite material ha s a mean flow pore size of at least 2× larger than the volume-average particle size of the metal nanoparticles.

8.-11. (canceled)

12. The composite material of claim 1, wherein the composite material comprises an ion exchange material; or
wherein the ion exchange material is selected from one of an anion exchange material and a cation exchange material; or
wherein the ion exchange material is selected from a hydrocarbon polymer, a fluorocarbon polymer and a perfluorocarbon polymer; or
wherein the ion exchange material is a perfluorosulfonic acid.

13.-15. (canceled)

16. A membrane electrode assembly comprising the composite material of claim 1 coupled to an electrochemical separator.

17. The membrane electrode assembly of claim 16, wherein the electrochemical separator comprises an ion exchange material.

18. The membrane electrode assembly of claim 17, wherein the ion exchange material is selected from one of an anion exchange material and a cation exchange material.

19. The membrane electrode assembly of claim 18, wherein the ion exchange material is selected from a hydrocarbon polymer, a fluorocarbon polymer, and a perfluorocarbon polymer.

20. The membrane electrode assembly of claim 18, wherein the ion exchange material is a perfluorosulfonic acid.

21. An article including the composite material of claim 1, wherein the article is an electrochemical cell, a fuel cell, or an electrolyzer.

22.-24. (canceled)

25. A method of forming a composite material, comprising:
providing a polymer substrate having a porous structure;
imbibing the polymer substrate with metal nanoparticles; and
heating the metal nanoparticles to sinter the metal nanoparticles to form a conformal coating on a surface of the polymer substrate.

26. The method of claim 25, further comprising preparing a dispersion including the metal nanoparticles and a dispersing agent, wherein imbibing includes wetting the polymer substrate with the dispersion.

27. The method of claim 25, wherein imbibing the polymer substrate includes heating the polymer substrate to a first temperature at which a processing aid is volatilized, and wherein heating the metal nanoparticles includes heating the metal nanoparticles to a second temperature to sinter the metal nanoparticles.

28. The method of claim 27, wherein the second temperature at which the nanoparticles are sintered is lower than a melting temperature of the polymer substrate; or
wherein the first temp is about 90 degrees Celsius and the second temperature is about 300 de s Celsius; or
wherein a porous structure defines an interior surface and the metal coating is positioned on interior surfaces of the polymer substrate continuous metal coating on the porous structure, including the interior surface, of the polymer substrate;
wherein the metal coating is se ted from one of a platinum coating, iridium coating, ruthenium coating, palladium coating, gold coting, silver coating, copper coating, nickel coating, indium coating, combinations thereof, alloys thereof, including alloys with transition metals, and/or oxides thereof.

29.-31. (canceled)

32. The method of claim 25, wherein the polymer substrate is a membrane selected from one of expanded polytetrafluoroethylene and expanded polyethylene.

33. (canceled)

34. The composite material of claim 1, wherein the conformal coating is a conductive coating having a metal retention of greater than 90 wt %.
